(19) United States
(12) Patent Application Publication
(10) Pub. No.: US 2005/0278762 A1
(43) Pub. Date: Dec. 15, 2005

(54) System and method for capacity allocation in HFC CATV networks

(76) Inventors: John G. Leddy, Philadelphia, PA (US); Vivek Saxena, Philadelphia, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/864,296

(22) Filed: Jun. 9, 2004

(51) Int. Cl. H04N 7/173

(52) U.S. Cl. 725/95; 725/129

(57) ABSTRACT

A system and method for allocating capacity in a hybrid cable television network transmits different channels on the same radio frequency sub-carrier of different carriers. This allows a part of the allocated downstream radio frequency spectrum to be reused by utilizing multiple carriers. Carriers selection at a downstream location determines which channel is received by any particular subscriber. In this way, services can be tailored to subscriber groups.

### BACKGROUND OF THE INVENTION

1. Field of the Invention

The invention relates to capacity allocation in hybrid fiber coax (HFC) cable television (CATV) networks.

2. Background Art

The HFC CATV network includes a headend that distributes signals over fiber to field nodes in the network. From the field nodes, distribution through the neighborhoods to the subscribers is over coax cable.

For traditional broadcast TV service, most HFC CATV systems collect satellite and trunk cable feeds, local off-the-air television channels, and other video/audio channels, and distribute them from the headend to the field node on a fiber using an amplitude modulated vestigial sideband (AM-VSB) scheme which places channels onto different sub-carriers within the frequency spectrum allocated for CATV downstream transmission (55/65 MHz to 750/860/1000 MHz) so that each channel occupies 6 MHz of the spectrum.

On the other hand, most new services being offered on cable such as video-on-demand (VOD), digital TV, high-speed data (HSD), and IP telephony, are distributed by using multilevel quadrature amplitude modulation (M-QAM) of sub-carriers within the 55-860 MHz range. In the M-QAM scheme, both amplitude and phase of the sub-carrier are varied to represent each digital symbol. For example, in a 256 QAM, 256 combinations of amplitude and phase are used.

The M-QAM channels may either be combined with the AM-VSB channels and the combined RF signal may drive the same laser (this is referred to as hybrid multichannel AM-VSB/M-QAM transport architecture), or the two types of modulated channels could drive separate lasers independently and then be transmitted on different fibers.

There is still a desire for an improved method and system for capacity allocation in HFC CATV networks.

### SUMMARY OF THE INVENTION

It is an object of the invention to provide an improved system and method for capacity allocation in HFC CATV networks.

In carrying out the invention, methods and systems are provided. In one aspect of the invention, a method for allocating capacity in a hybrid fiber coax (HFC) cable television (CATV) network is provided. The cable television network includes a headend that distributes signals over fiber to field nodes in the cable television network. The signals are distributed through the neighborhoods to subscribers from the field nodes. The distributed signals from the headend include a plurality of channels containing digital data for cable television services. The digital data are modulated onto radio frequency sub-carriers within an allocated downstream radio frequency spectrum.

The method comprises transmitting the plurality of channels from a transmitting system. Each channel contains digital data that are modulated onto a radio frequency sub-carrier within the allocated downstream radio frequency spectrum. The radio frequency sub-carriers are modulated onto carriers. The same radio frequency sub-carrier carries different channels on different carriers, thereby allowing a part of the allocated downstream radio frequency spectrum to be reused by utilizing multiple carriers.

The method further comprises selectively passing a group of carriers such that a combined radio frequency spectrum is determined by the passed group of carriers. In this way, through carrier selection, the particular channel for each particular sub-carrier in the combined radio frequency spectrum is determined.

The method further comprises receiving the passed group of carriers at a receiving system. The receiving system produces the combined radio frequency spectrum and distributes the combined radio frequency spectrum to a user group. In this way, the carrier group selection allows the combined radio frequency spectrum to be tailored to the user group.

At a more detailed level, the invention comprehends additional features. In the preferred implementation, the transmitting system includes an array of lasers. The transmitting system utilizes wavelength division multiplexing (WDM) to combine different wavelengths from the laser array and launch them onto a single fiber as the carriers. The receiving system includes a photo device having an output. The optical signals for the passed group of carriers impinge on the photo device to produce the combined radio frequency spectrum at the photo device output. Carrier selection may be performed in any suitable way, such as, for example, by using a tunable optical filter or using a wavelength blocker at a location between the transmitting and receiving systems. The means for selectively passing the group of carriers may be any device capable of discriminating carriers. Further, in the preferred arrangement, the transmitting system utilizes dense wavelength division multiplexing (DWDM), and the photo device is a photodiode.

Further, at a more detailed level, the invention comprehends utilizing multilevel quadrature amplitude modulation (M-QAM) for radio frequency sub-carriers for downstream transmission of the digital data. Further, the digital data may be for any number of CATV services including, for example, voice, video, and Internet access.

The invention further comprehends the allocated downstream radio frequency spectrum being split such that the different parts of the radio frequency spectrum are transmitted by separate carriers. The different parts of the allocated downstream radio frequency spectrum may correspond to different cable television services. Further, different carriers may be utilized to offer alternative services for a particular part of the allocated downstream radio frequency spectrum with carrier selection dictating the particular services provided in that part of the spectrum.

It is appreciated that, in another aspect of the invention, systems and methods are not limited to a particular cable television network architecture. Further, in carrying out the invention, a method for allocating capacity in a hybrid cable television (CATV) network is provided. The cable television network includes a headend that distributes signals over a first network portion to field nodes in the cable television network. The signals are distributed through the neighborhoods to subscribers from the field nodes over a second network portion. The second network portion has limited available bandwidth relative to the first network portion. The distributed signals from the headend include a plurality of channels containing digital data for cable television services. The digital data are modulated onto radio frequency sub-carriers within an allocated downstream radio frequency spectrum.

The method comprises transmitting the plurality of channels over the first network portion from a transmitting system. The same radio frequency sub-carrier carries different channels on different carriers, thereby allowing a part of the allocated downstream radio frequency spectrum to be reused by utilizing multiple carriers.

The method further comprises selectively passing a group of carriers such that a combined radio frequency spectrum is determined by the passed group of carriers. The passed group of carriers is received at a receiving system. The receiving system produces the combined radio frequency spectrum and distributes the combined radio frequency spectrum over the second network portion to a user group. In this way, the carrier group selection allows the combined radio frequency spectrum to be tailored to the user group.

### BRIEF DESCRIPTION OF THE DRAWINGS

FIG. 1 is a hybrid fiber coax (HFC) cable television (CATV) network in which an embodiment of the invention is illustrated;

FIG. 2 is a hybrid fiber coax (HFC) cable television (CATV) network in which another embodiment of the invention is illustrated; and

FIG. 3 is a block diagram illustrating a method in an embodiment of the invention.

### DETAILED DESCRIPTION OF THE PREFERRED EMBODIMENTS

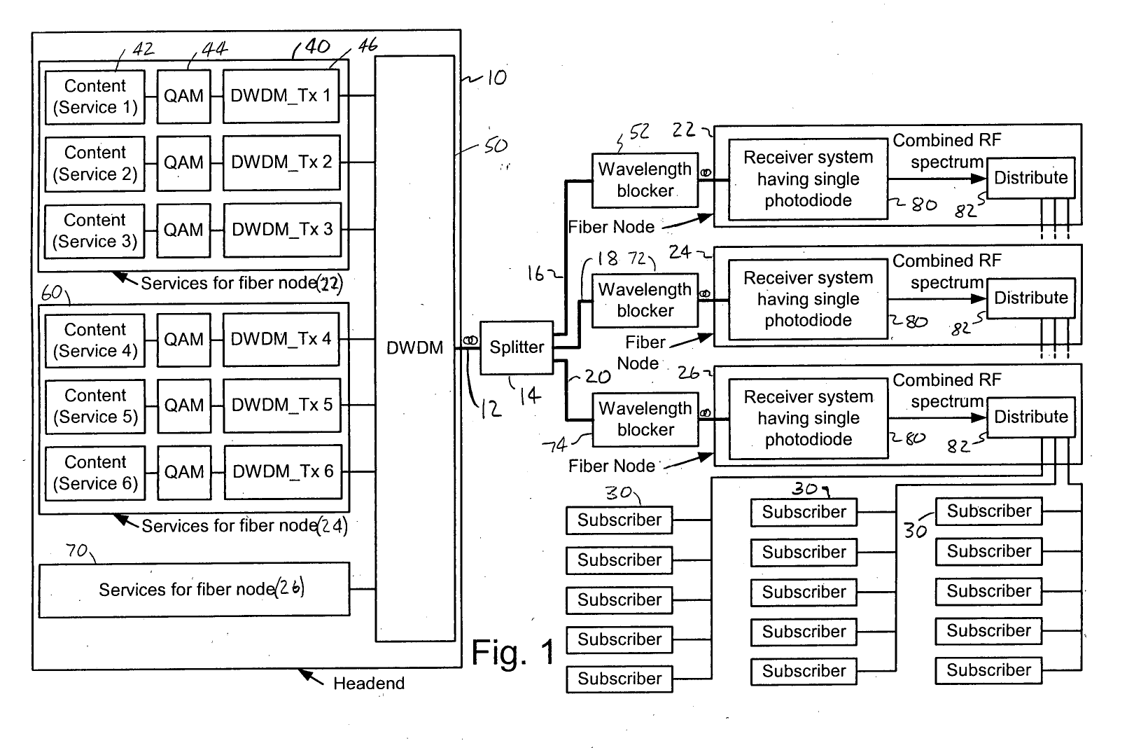

With reference to FIG. 1, the HFC CATV network includes a headend 10 that receives content from a number of content sources. Headend 10 distributes signals over fiber 12 through splitter 14. The signals are further distributed over fibers 16, 18, 20 to fiber nodes 22, 24, 26. From fiber nodes 22, 24, 26, distribution through the neighborhoods to subscribers 30 takes place over coax cable. The HFC CATV network architecture is illustrated in a simplified fashion.

The HFC CATV network provides multiple services. Content from content sources is processed in a known fashion to produce various channels containing digital data for CATV services. The digital data is modulated onto radio frequency (RF) sub-carriers within an allocated downstream RF spectrum. As shown, multilevel quadrature amplitude modulation (M-QAM) of the RF sub-carriers is utilized in the downstream transmission of the digital data. The digital data itself may be for any number of CATV services including, for example, voice, video, and Internet access.

The allocated downstream RF spectrum for a subscriber is split such that different parts of the RF spectrum are transmitted by separate dense wavelength division multiplexed (DWDM) lasers in a DWDM transmitter system 50 including an array of such lasers. DWDM transmitter system 50 utilizes dense wavelength division multiplexing (DWDM) to combine different wavelengths from the laser array on the transmitter side and then launch them onto a single fiber 12. DWDM is used to combine the different International Telecommunications Union (ITU) grid wavelengths from the laser array on the transmitter side and launch them on the single fiber 12.

With continuing reference to FIG. 1, services for fiber node 22 are indicated at block 40. Each service family within block 40 is transmitted by a separate DWDM laser. For example, content block 42 provides digital data that are modulated onto RF sub-carriers by QAM array 44. This part of the allocated downstream RF spectrum is transmitted by a separate DWDM laser as depicted by block 46. The other parts of the RF spectrum are transmitted by the remaining DWDM lasers in block 40.

On the receiver side for fiber node 22, a receiver system 80 having a single photodiode receives the signal from fiber 12 (which passes through splitter 14, fiber 16, wavelength blocker 52, to receiver system 80). Receiver system 80 reproduces the combined RF spectrum (from block 40) at its output. Distribution block 82 distributes the combined RF spectrum in a known fashion to subscribers 30. Wavelength blocker 52 is configured to block wavelengths other than those associated with the services for fiber node 22 which originate at block 40.

In accordance with embodiments of the invention, subscribers may be split into groups. With continuing reference to FIG. 1, services for fiber node 24 are indicated at block 60. These services are provided via digital data modulated onto RF sub-carriers within an allocated downstream RF spectrum. The lasers used to carry services 60 to fiber node 24 have different wavelengths than the lasers used to carry services 40 to fiber node 22. In this way, wavelength blocker 72 blocks all wavelengths other than those providing services intended for fiber node 24, and in the same way, wavelength blocker 52 blocks all wavelengths other than those providing services intended for fiber node 22. This allows reuse of the RF spectrum at the headend 10, and through carrier group selection by the wavelength blockers, allows tailoring of the received RF spectrum to each subscriber group.

In this same way, services for fiber node 26 are indicated at block 70. These services are provided on one or more lasers with wavelength blocker 74 blocking any wavelengths other than those carrying services intended for fiber node 26.

This arrangement allows the subscribers to be split into groups (as shown, each fiber node corresponds to a group). This allows the downstream RF spectrum to be reused at headend 10, thereby allowing allocation of new capacity to the coaxial plant. The wavelength blockers may be dynamically configured in certain applications.

It is appreciated that although entirely separate groups of services for each fiber node are shown at the headend 10, this approach is not required. The various lasers may carry various different parts of the RF spectrum, with a wavelength blocker only being required to pass a group of carriers that determines a complete RF spectrum for subscribers. In this way, some carriers may go to only a single subscriber group while other carriers are passed to all subscriber groups. The important aspect is that the wavelength blocker only passes a sufficiently limited group of carriers such that the RF spectrum is determined.

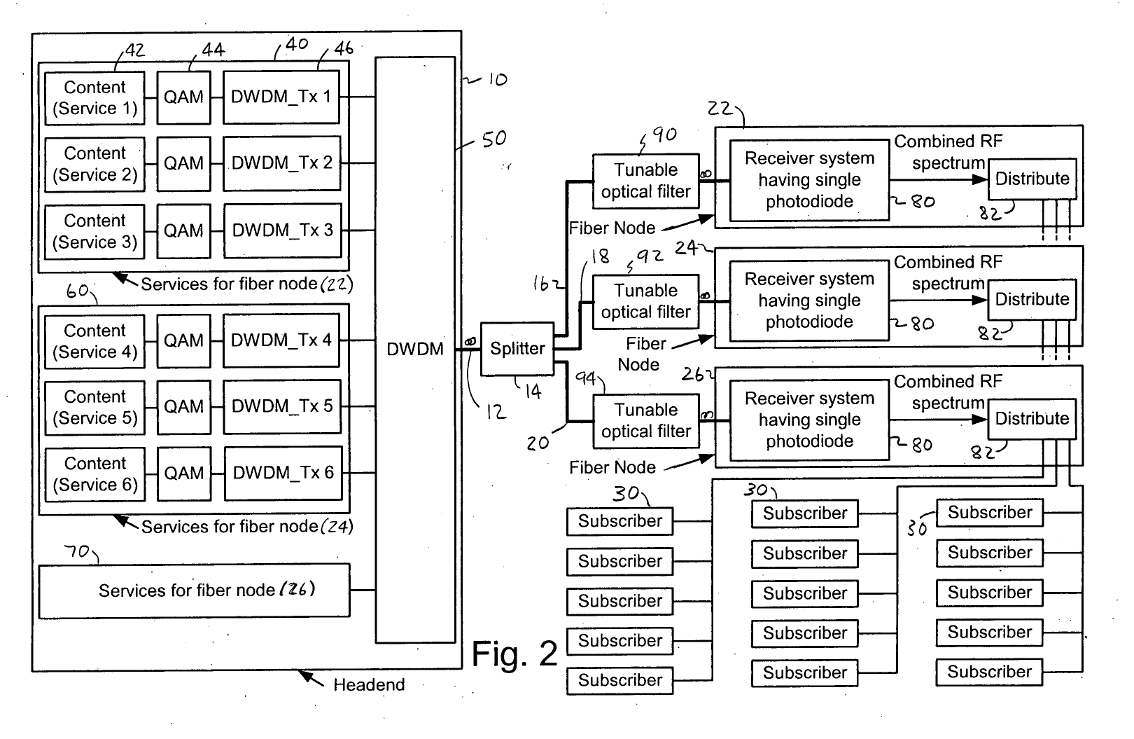

With reference to FIG. 2, a hybrid fiber coax (HFC) cable television (CATV) network is illustrated. The implementation illustrated in FIG. 2 uses tunable optical filters 90, 92, 94 instead of wavelength blockers (52, 72, 74, in FIG. 1).

It is appreciated that the physical location of a wavelength blocker or tunable optical filter may vary depending on the implementation. For example, the wavelength blocker or tunable optical filter may be located at a hub between the headend and fiber node. Further, in certain applications the wavelength blocker approach may have an advantage over the tunable optical filter approach as the wavelength blocker may allow multiple light colors to pass through while the tunable optical filter would typically be tuned to a single color.

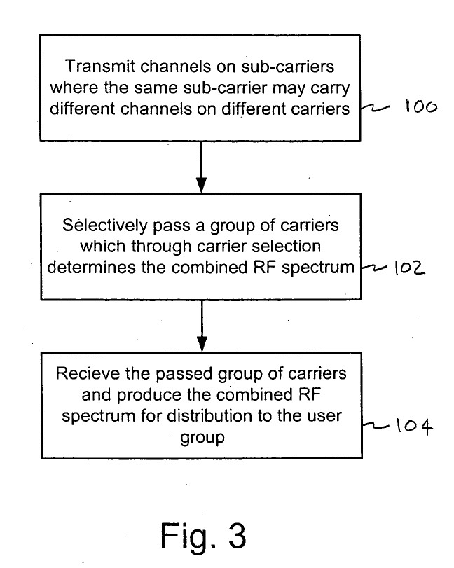

With reference to FIG. 3, a block diagram illustrates a method in an embodiment of the invention.

At block 100, a plurality of channels are transmitted from a transmitting system. Each channel contains digital data that are modulated onto a radio frequency sub-carrier within the allocated downstream RF spectrum. The RF sub-carriers are modulated onto carriers. The same RF sub-carrier may carry different channels when it is placed on different carriers, thereby allowing a part of the allocated downstream radio frequency spectrum to be reused by utilizing multiple carriers.

At block 102, a group of carriers is selectively passed such that a combined radio frequency spectrum is determined by the passed group of carriers. In this way, through carrier selection, the particular channel for each particular sub-carrier in the combined radio frequency spectrum is determined.

At block 104, the passed group of carriers is received at a receiving system. The receiving system produces the combined radio frequency spectrum and distributes the combined radio frequency spectrum to a user group. The carrier group selection allows the combined radio frequency spectrum to be tailored to the user group.

It is appreciated that the illustrated embodiment employs a number of detail features that are preferred but other implementations are possible. In the preferred embodiment, digital data are modulated onto the radio frequency sub-carriers within the allocated downstream radio frequency spectrum utilizing multilevel quadrature amplitude modulation (M-QAM). Further, the transmitter system utilizes dense wavelength division multiplexing (DWDM).

Due to the large amounts of content that can be transmitted using M-QAM (for example, 256 QAM allows transmission of 12 movies with a 6 MHz channel at 3 Mb/s per second using digital video compression) it is desirable to split the 55-860 MHz RF spectrum such that distinct parts of the spectrum are dedicated to different services and transmitted by different lasers. More specifically, the downstream RF spectrum (for each subscriber group) is split such that different parts of the RF spectrum are transmitted by different lasers within the array. The different parts of the RF spectrum correspond to different CATV services including, for example, voice, video, and Internet access.

The preferred arrangement utilizes dense wavelength division multiplexing (DWDM) to combine the different ITU grid wavelengths from the laser array on the transmitter side and launch them on a single fiber from the headend. On the receive side, the unfiltered optical signal impinges on a single photodiode which reproduces the combined RF spectrum at its output. Wavelength blockers, tuneable filters, or other means are used to pass an appropriate group of carriers (that determine an RF spectrum) to each receiving diode.

In the preferred embodiments of the invention, the implementation is specifically tailored to better address interferometric noise and thermal noise.

Interferometric noise arising from the optical beat frequencies (OBI) results from two or more lasers transmitting simultaneously onto the same optical channel. Due to the square law nature of the photo-detection process, the generated photo current would contain beat notes at frequencies corresponding to the differences in optical wavelengths. OBI worsens as the number of lasers increase or as the wavelengths are brought closer. To address this concern, in preferred embodiments, the ITU grid wavelengths should be selected such that they are farthest apart from each other while at the same time still fulfilling the requirements on the number of channels and optical transmission band(s). Another concern is the increase in the amount of thermal noise (electron agitation in a conductor) in the system since each laser is an independent source and thus the total noise power is the sum of the original noise powers (often expressed as relative intensity noise in a 1 Hz bandwidth) for the lasers. This increase in the thermal noise places a penalty on the carrier to noise (CNR) ratio. To address this concern in preferred embodiments, since the CNR required for M-QAM signals to achieve an acceptable bit error rate (BER) threshold is much lower (for example, 28 dB for BER of 10⁻⁸ for 64 QAM) than the CNR require for AM-VSB signals (43 dB CNR requirement as the subscriber), an architecture that uses all M-QAM channels could make this penalty insignificant.

There will be a 3 dB QAM SNR (Signal to Noise Ratio) degradation at the channels bordering the spectrum edges. Due to this degradation, these channels should be dedicated to services with a lower SNR requirement (such as data services) instead of SNR-sensitive video service. The flexibility in the architecture allows such RF frequency allocations. Alternately if the entire spectrum needs to be used for QAM-based video, a 3 dB system penalty would be incurred. As an alternative to incurring the penalty, preliminary amplification of channels bordering the spectrum edges may be used.

It is appreciated that in preferred embodiments, an all digital data transport using M-QAM is utilized instead of a hybrid architecture. This approach addresses AM-VSB limitations including laser clipping and frequency-chirp. However, in certain implementations AM-VSB channels could be added on a separate wavelength provided of course that there is no RF spectrum overlap on any carriers that are intended for same node.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for allocating capacity in a hybrid fiber coax (HFC) cable television (CATV) network, the cable television network including a headend that distributes signals over fiber to field nodes in the cable television network, the signals being distributed through the neighborhoods to subscribers from the field nodes, the distributed signals from the headend including a plurality of channels containing digital data for cable television services, the digital data being modulated onto radio frequency sub-carriers within an allocated downstream radio frequency spectrum, the method comprising:
transmitting the plurality of channels from a transmitting system, each channel containing digital data that is modulated onto a radio frequency sub-carrier within the allocated downstream radio frequency spectrum, the radio frequency sub-carriers being modulated onto carriers, wherein the same radio frequency sub-carrier carries different channels on different carriers thereby allowing a part of the allocated downstream radio frequency spectrum to be reused by utilizing multiple carriers;
selectively passing a group of carriers such that a combined radio frequency spectrum is determined by the passed group of carriers thereby, through carrier selection, determining the particular channel for each particular sub-carrier in the combined radio frequency spectrum; and
receiving the passed group of carriers at a receiving system, the receiving system producing the combined radio frequency spectrum and distributing the combined radio frequency spectrum to a user group, whereby the carrier group selection allows the combined radio frequency spectrum to be tailored to the user group.

2. The method of claim 1 wherein the transmitting system includes an array of lasers, the transmitting system utilizing wavelength division multiplexing (WDM) to combine different wavelengths from the laser array and launch them onto a single fiber as the carriers, and wherein the receiving system includes a photo device having an output, the optical signals for the passed group of carriers impinging on the photo device to produce the combined radio frequency spectrum at the photo device output.

3. The method of claim 2 wherein carrier selection is performed using a tunable optical filter.

4. The method of claim 2 wherein carrier selection is performed using a wavelength blocker.

5. The method of claim 2 wherein the transmitting system utilizes dense wavelength division multiplexing (DWDM).

6. The method of claim 2 wherein the photo device is a photodiode.

7. The method of claim 1 wherein the digital data is modulated onto the radio frequency sub-carriers within the allocated downstream radio frequency spectrum utilizing multilevel quadrature amplitude modulation (M-QAM).

8. The method of claim 1 wherein the digital data include digital data for voice service.

9. The method of claim 1 wherein the digital data include digital data for video service.

10. The method of claim 1 wherein the digital data include digital data for Internet access service.

11. The method of claim 1 wherein different parts of the allocated downstream radio frequency spectrum correspond to different cable television services, and wherein different carriers are utilized to offer alternative services for a particular part of the allocated downstream radio frequency spectrum.

12. The method of claim 1 further comprising:
selectively passing a second group of carriers such that a second combined radio frequency spectrum is determined by the passed second group of carriers thereby, through carrier selection, determining the particular channel for each particular sub-carrier in the second combined radio frequency spectrum; and
receiving the passed second group of carriers at a second receiving system, the second receiving system producing the second combined radio frequency spectrum and distributing the second combined radio frequency spectrum to a second user group, whereby the carrier group selection allows the second combined radio frequency spectrum to be tailored to the second user group.

13. The method of claim 12 wherein the transmitting system includes an array of lasers, the transmitting system utilizing wavelength division multiplexing (WDM) to combine different wavelengths from the laser array and launch them onto a single fiber as the carriers, and wherein the receiving system includes a photo device having an output, the optical signals for the passed group of carriers impinging on the photo device to produce the combined radio frequency spectrum at the photo device output.

14. The method of claim 13 wherein carrier selection is performed using a tunable optical filter.

15. The method of claim 13 wherein carrier selection is performed using a wavelength blocker.

16. The method of claim 13 wherein the transmitting system utilizes dense wavelength division multiplexing (DWDM).

17. The method of claim 13 wherein the photo device is a photodiode.

18. The method of claim 12 wherein different parts of the allocated downstream radio frequency spectrum correspond to different cable television services, and wherein different carriers are utilized to offer alternative services for a particular part of the allocated downstream radio frequency spectrum thereby allowing different user groups to receive different services in the same part of the allocated downstream radio frequency spectrum.

19. A system for allocating capacity in a hybrid fiber coax (HFC) cable television (CATV) network, the cable television network including a headend that distributes signals over fiber to field nodes in the cable television network, the signals being distributed through the neighborhoods to subscribers from the field nodes, the distributed signals from the headend including a plurality of channels containing digital data for cable television services, the digital data being modulated onto radio frequency sub-carriers within an allocated downstream radio frequency spectrum, the system comprising:
a transmitting system for transmitting the plurality of channels, each channel containing digital data that is modulated onto a radio frequency sub-carrier within the allocated downstream radio frequency spectrum, the radio frequency sub-carriers being modulated onto carriers, wherein the same radio frequency sub-carrier carries different channels on different carriers thereby allowing a part of the allocated downstream radio frequency spectrum to be reused by utilizing multiple carriers;
means for selectively passing a group of carriers such that a combined radio frequency spectrum is determined by the passed group of carriers thereby, through carrier selection, determining the particular channel for each particular sub-carrier in the combined radio frequency spectrum; and
a receiving system for receiving the passed group of carriers, the receiving system producing the combined radio frequency spectrum and distributing the combined radio frequency spectrum to a user group, whereby the carrier group selection allows the combined radio frequency spectrum to be tailored to the user group.

20. The system of claim 19 wherein the transmitting system includes an array of lasers, the transmitting system utilizing wavelength division multiplexing (WDM) to combine different wavelengths from the laser array and launch them onto a single fiber as the carriers, and wherein the receiving system includes a photo device having an output, the optical signals for the passed group of carriers impinging on the photo device to produce the combined radio frequency spectrum at the photo device output.

21. The system of claim 20 wherein carrier selection is performed using a tunable optical filter.

22. The system of claim 20 wherein carrier selection is performed using a wavelength blocker.

23. A method for allocating capacity in a hybrid cable television (CATV) network, the cable television network including a headend that distributes signals over a first network portion to field nodes in the cable television network, the signals being distributed through the neighborhoods to subscribers from the field nodes over a second network portion, the second network portion having limited available bandwidth relative to the first network portion, the distributed signals from the headend including a plurality of channels containing digital data for cable television services, the digital data being modulated onto radio frequency sub-carriers within an allocated downstream radio frequency spectrum, the method comprising:
transmitting the plurality of channels over the first network portion from a transmitting system, each channel containing digital data that is modulated onto a radio frequency sub-carrier within the allocated downstream radio frequency spectrum, the radio frequency sub-carriers being modulated onto carriers, wherein the same radio frequency sub-carrier carries different channels on different carriers thereby allowing a part of the allocated downstream radio frequency spectrum to be reused by utilizing multiple carriers;
selectively passing a group of carriers such that a combined radio frequency spectrum is determined by the passed group of carriers thereby, through carrier selection, determining the particular channel for each particular sub-carrier in the combined radio frequency spectrum; and
receiving the passed group of carriers at a receiving system, the receiving system producing the combined radio frequency spectrum and distributing the combined radio frequency spectrum over the second network portion to a user group, whereby the carrier group selection allows the combined radio frequency spectrum to be tailored to the user group.
